(19) United States
(12) Patent Application Publication
(10) Pub. No.: US 2019/0031295 A1
(43) Pub. Date: Jan. 31, 2019

(54) Kayak Transport Tool

(71) Applicant: Peter J. Rosewicz, Sussex, WI (US)

(72) Inventor: Peter J. Rosewicz, Sussex, WI (US)

(21) Appl. No.: 15/665,178

(22) Filed: Jul. 31, 2017

(51) Int. Cl. B63B 21/04; B65H 75/34; B66D 1/30

(52) U.S. Cl. CPC B63B 21/04; B65H 75/00; B66D 1/30; B65H 75/34

(57) ABSTRACT

The subject invention is a buoyant retractable watercraft safety line comprised of a housing adapted for mounting on a personal watercraft which encloses an internal self-winding and locking line spool assembly.

### FIELD OF INVENTION

This invention relates to the field of rescue and safety devices and more specifically to a retractable tow rope device.

### BACKGROUND OF THE INVENTION

Kayaks and small watercraft are often transported to be placed in the water or during emergencies by pulling them from the bow or stern.

Kayak and watercraft handles integrally molded into the watercraft structure are difficult to grasp to drag the watercraft across dry land.

Additionally, The US Coast Guard recommends that all small personal water craft be equipped with accessible safety ropes or tie off lines on both the bow and stern of the water craft. These unsecured lines create trip and snag hazards, and may be difficult to locate in an emergency.

If they are loose on the floor of the watercraft or are inadvertently dropped on the ground, they present a trip hazard. When carrying or portaging a personal watercraft, the line may become snagged on brush or a tree.

There is an unmet need for a tool for transporting and towing a small watercraft and for securing safety lines.

### BRIEF SUMMARY OF THE INVENTION

The invention is a device that provides a retractable watercraft safety line that may be selectively affixed to a dock. Components of the device include a rope, a novel, simplified spring retraction assembly that utilizes release pin for securing and retracting the rope. The spring retraction assembly is partially enclosed by non-absorbent, non-corrosive housing with an aperture that allows for drainage.

### BRIEF DESCRIPTION OF SEVERAL VIEWS OF THE DRAWING(S)

FIG. 1 illustrates an exemplary embodiment of a retractable watercraft safety line.

FIG. 2 illustrates an exploded view of a retractable watercraft safety line.

FIGS. 3a, 3b, and 3c illustrate examples of an exemplary retractable watercraft safety line in use.

### TERMS OF ART

As used herein, the term “trapezoidal” means a four-sided shape wherein the sides may be straight or curved.

As used herein, the term “anthropometric” means adapted for human anatomy.

As used herein, the term “substantially” means all or a material portion; recognizable but modified or materially characterized by a feature, trait or composition.

As used herein, the term “gripping component” means a protuberance or contour or any other anthropometric feature for gripping by a human hand.

As used herein, the term “rope” or “webbing” means rope, lanyard, line, or cord made of materials such as polyester, polydacron, polypropylene, nylon, and Kevlar.

As used herein, the term “flotation component” may include Styrofoam, Air bladder, foaming agent inserted into a cavity, air tight sealed compartment or cork.

As used herein, the term “operatively coupled” means mechanically interdependent or components which interact physically when a common force, movement, or method of activation is applied.

### DETAILED DESCRIPTION OF THE INVENTION

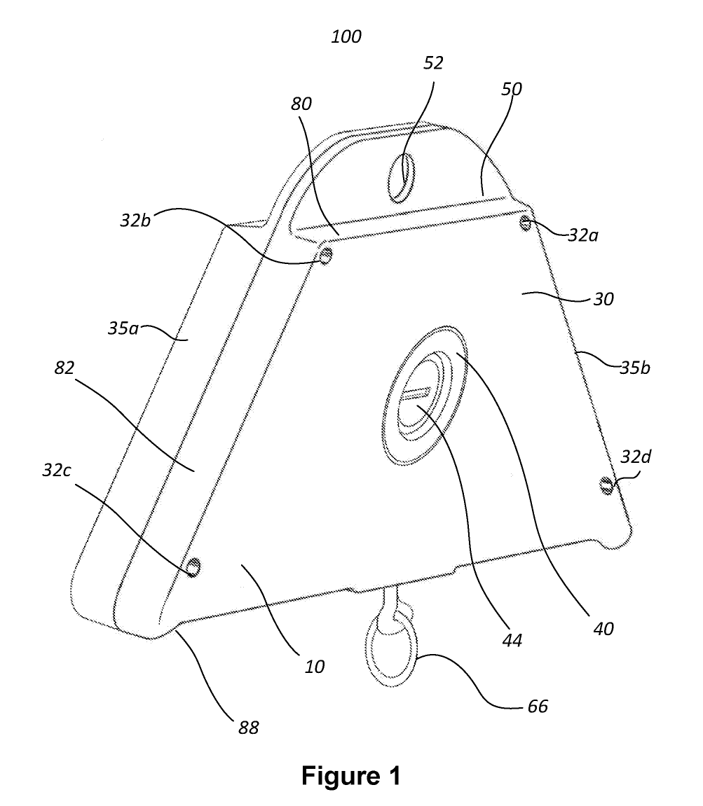

FIG. 1 illustrates an exemplary embodiment of retractable watercraft safety line 100. Retractable watercraft safety line 100 is affixed to a watercart and provides a retractable rope that is available in emergency situations and for use securing a watercraft.

In the embodiment shown, housing 30 is comprised of two sectional components 35a, 35b. Other embodiments may include a single integrally molded component, or housing 30 may be formed by more components.

In the embodiment shown, release pin 76 is a cylindrical tube with a solid pin, but in other embodiments release pin 76 may include a toothed sprocket. When spring release button 40 is depressed, release pin 76 is disengaged from retraction assembly 70 allowing rope 60 to be freely pulled from housing 30, or returned to the original coiled position. In the embodiment shown spring release button 40 protrudes through spring release button aperture (not shown) and is held in place by a securing mechanism, which in the embodiment shown is release pin assembly screw 44.

In other embodiments, alternative securing mechanism may be used such as designing spring release button 40 so that it can be repositioned within an aperture or slot and held into place with contact from another component.

FIG. 1 further illustrates an optional attachment ring 62 to facilitate attachment of rope 60 to a watercraft. Alternative means of attachment may be used including hooks, carabiners, ties and brackets and portions of rope 60.

In various embodiment rope 60 may be made of lanyard, line, or cord and made of materials such as polyester, polydacron, polypropylene, nylon, and Kevlar. Rope 60 may be between 10 to 15 feet in length, 0.125 to 0.3125-inch diameter and have a tensile strength ranging from 140 to 600 pounds per square inch. The webbing may be 10 to 15 feet in length, 0.375 to 0.75 inches wide 0.020 to 0.469 inches thick and have a tensile strength of 140 to 1,000 pounds per square inch.

In the exemplary embodiment shown housing 30 further includes trapezoidal top surface 10. Other embodiments may utilize different geometry for housing 30, including oval, flat oval, half round, modified square, or modified rectangle.

In FIG. 1 first perimeter surface 80 and second perimeter surface 82 are visible. Anthropometric gripping component 88 having contoured finger ridges, 1.25 inches thick by 3.5 inches wide for optimal hand comfort, is also visible on perimeter surface 86. In the embodiment shown, perimeter surface 80 includes optional accessory mounting panel 50 with mounting aperture 52, which allows attachment of additional objects such as an s-hook, carabiner, shackle, clasp, housing colors, rope colors, led lighting, or waterproof GPS system to be mounted to watercraft safety tow 100. Other embodiments may include an outside rubber case for device protection and user comfort.

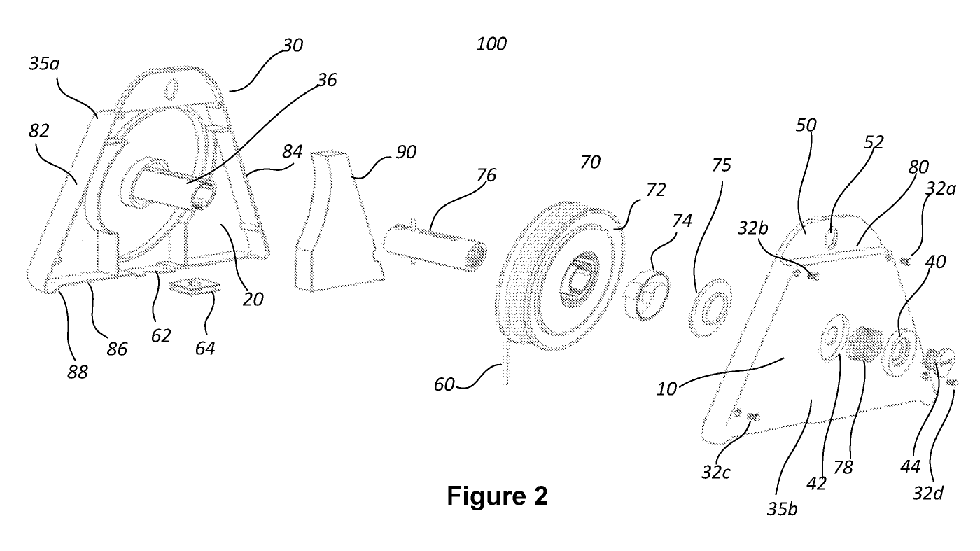

FIG. 2 illustrates an exploded view of retractable watercraft safety line 100. In the exemplary embodiment shown, housing 30 has four perimeter surfaces; other embodiments may have more or fewer surfaces. FIG. 2 illustrates an embodiment of housing 30 including third perimeter surface 84, fourth perimeter surface 86 and trapezoidal bottom surface 20. FIG. 2 further illustrates inner cavity 36 to accommodate retraction assembly 70, and flotation component 90. The volume of inner cavity is proportional to the size of spool 72. Spool 72 is 1-inch-thick by 2.75-inch diameter and has a 1.25-inch diameter hole in the core. In the embodiment shown, retraction assembly 70 which can withstand up to 250 pounds of a pulling force from rope 60, is comprised of spool 72, retraction spring 74, spring cover plate 75, and release pin 76. Rope 60 is secured by spool 72 which can be pulled through fourth perimeter surface 86 by means of rope exit aperture 62 and grommet 64. Trapezoidal top surface 10 includes spring release button 40, spring release button aperture 42, and button spring 78. Above first perimeter surface 80 is optional accessory mounting panel 50 with mounting aperture 52.

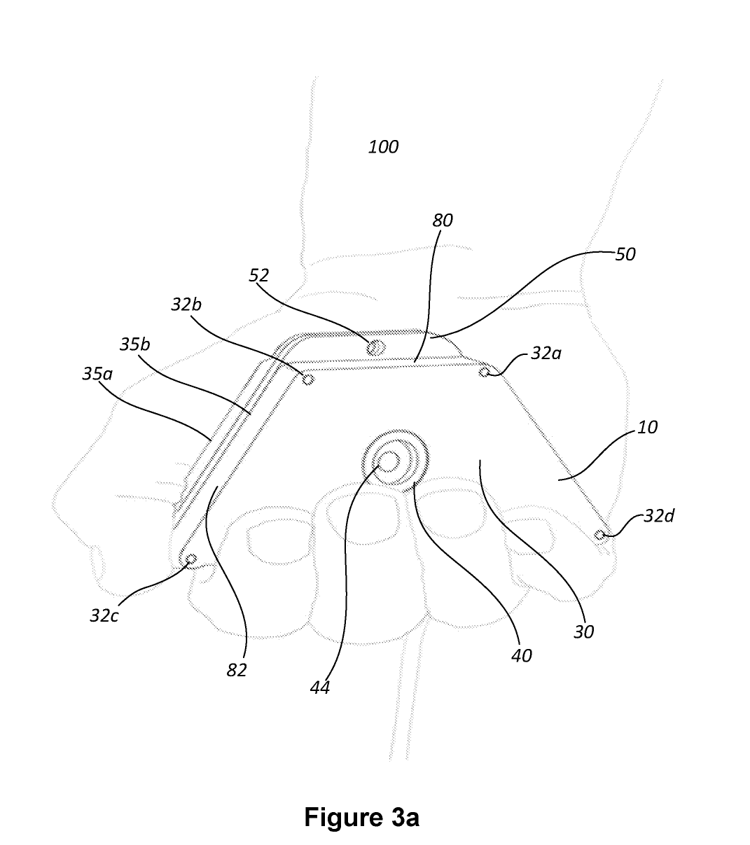

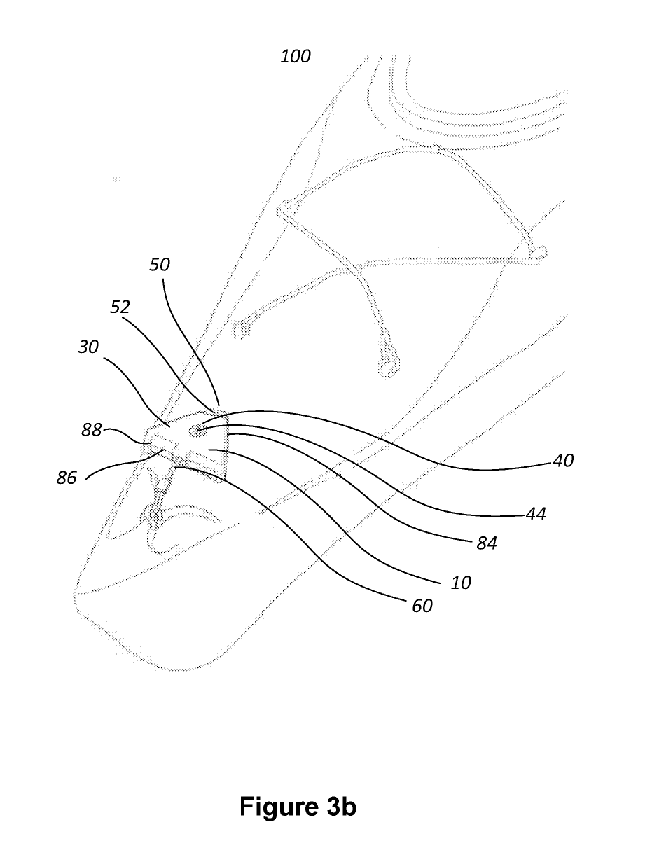

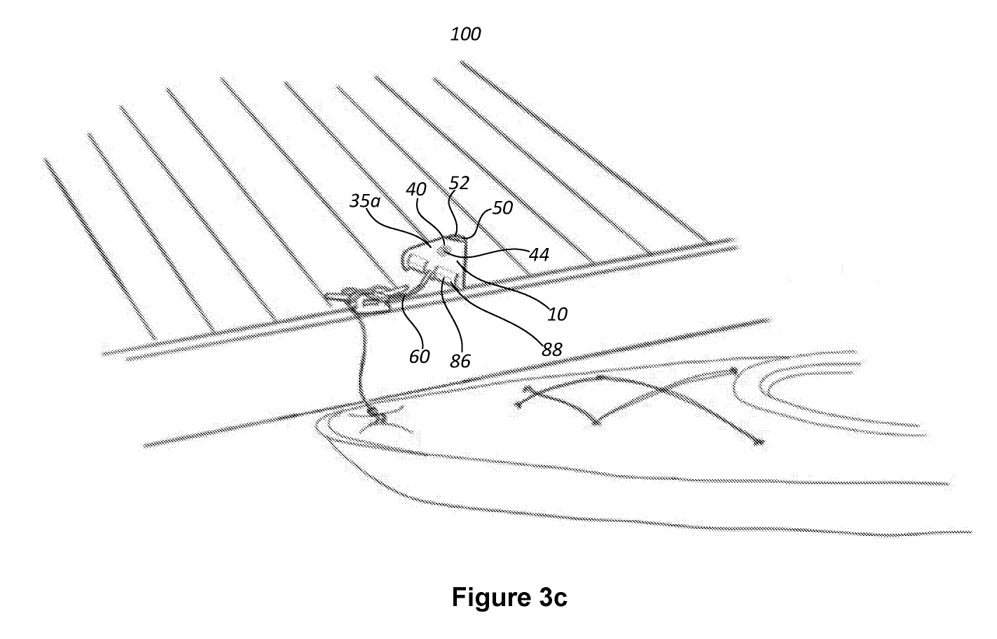

FIGS. 3a, 3b, and 3c further illustrate examples of retractable watercraft safety line 100 in use.

FIG. 3a illustrates an exemplary embodiment of retractable watercraft safety line 100 which is held in hand. In the embodiment shown, of retractable watercraft safety line 100 has dimensions ranging from 1 to 1.375 inches thick by 3.5 to 4.5 inches wide by 3 to 4.25 inches tall and weighing between 0.8 and 1.5 pounds.

FIG. 3a further illustrates housing 30, and trapezoidal top surface 10. In the embodiment shown, the volume of inner cavity 36 proportional to the size of spool 72. The size of spool 72 is proportional to the thickness and length of rope 60 to minimize the size and weight. Minimizing size and weight is further done by using light weight plastics and composites. By integrating the housing, spool and release pin in such a manner that all three elements support each other and support the anticipated load, the number of necessary components is decreased.

FIG. 3b illustrates an embodiment of retractable watercraft safety line 100 affixed to a kayak using rope 60.

FIG. 3c illustrates an embodiment of retractable watercraft safety line 100 in use to secure a kayak to a dock structure.

Additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the term “substantially” and “approximately” as used herein may be applied to modify any quantitative representation that could permissibly vary without resulting in a change in the basic function to which it is related.

What is claimed is:

1. Retractable watercraft safety line for affixation to a personal watercraft comprising:
a housing, comprising:
non-absorptive, non-corrosive materials,
a spring retraction assembly coupled with a release pin;
a rope comprising:
non-absorbent material; and
a flotation component.

2. The apparatus of claim 1 wherein said housing is comprised of a plurality of perimeter surfaces;
an inner cavity to hold said retraction assembly;
a trapezoidal top surface; and
a trapezoidal bottom surface.

3. The apparatus of claim 2 wherein at least one of said plurality of perimeter surfaces includes an anthropometric gripping contour.

4. The apparatus of claim 2 wherein at least one of said plurality of perimeter surfaces includes an exit aperture.

5. The apparatus of claim 2 wherein at least one of said plurality of perimeter surfaces includes an optional accessory mounting panel with a mounting structure.

6. The apparatus of claim 5 wherein said mounting structure can be an aperture or protuberance and attach accessories selected from a group consisting of an s-hook, carabineer, shackle, clasp, housing colors, rope colors, and led lighting.

7. The apparatus of claim 2 wherein said trapezoidal top surface is comprised of:
an aperture for a spring release button;
a button spring; and
a release pin assembly screw.

8. The apparatus of claim 1 wherein retraction assembly is comprised of:
a spool, being proportional to the size and diameter of said rope;
a release pin, operatively coupled with said spool;
a retraction spring, operatively coupled with said spool; and
a spring cover plate.

9. The apparatus of claim 1 wherein said rope further includes, an attachment ring.

10. The apparatus of claim 1 which further includes a flotation component within said housing.

11. The apparatus of claim 1 wherein said flotation component is selecting from a group comprised of Styrofoam, an air bladder, foaming agent, air tight sealed compartment or cork.

12. The apparatus of claim 1 wherein said rope is detachable for replacement;

13. The apparatus of claim 1 wherein said housing is comprised of two snap fit sectional components which may be selectively detached to access said rope.

14. The apparatus of claim 1 wherein said rope has a tensile strength of approximately 140 to 600 pounds per square inch.

15. The apparatus of claim 1 wherein said spool has a diameter of approximately 2.5 to 3.5-inch diameter.

16. The apparatus of claim 1 wherein said housing is approximately 1.25″ thick×4″ wide×4″ tall.

17. A small watercraft transport tool comprised of:
a handle with ergonomic structural components for gripping;
an attachment member for securing said handle to a personal watercraft;
wherein said handle includes a hollow inner chamber containing a rope operatively coupled with a spring retraction assembly coupled with a release pin.

18. The small watercraft transport tool of claim 17 wherein said ergonomic structural components for gripping include an anthropometric gripping contour.

19. The small watercraft transport tool of claim 17 wherein said spring retraction assembly includes an aperture for drainage.

20. The apparatus of claim 1 wherein said rope is detachable for replacement.
